(19) United States
(12) Patent Application Publication
(10) Pub. No.: US 2019/0279512 A1
(43) Pub. Date: Sep. 12, 2019

(54) VEHICLE CAMERAS FOR MONITORING OFF-ROAD TERRAIN

(71) Applicant: Ford Global Technologies, LLC., Dearborn, MI (US)

(72) Inventor: Joseph Daniel, Northville, MI (US)

(21) Appl. No.: 15/918,738

(22) Filed: Mar. 12, 2018

(51) Int. Cl. G08G 1/16; B60R 1/00; G05D 1/02; B60Q 9/00

(52) U.S. Cl. CPC G08G 1/165; B60R 1/003; G05D 1/0253; B60Q 9/008; B60R 2300/105; G05D 2201/0213; B60R 2300/307; B60R 2300/607; B60R 2300/8093; B60R 2300/205; B60R 2300/303

(57) ABSTRACT

Method and apparatus are disclosed for vehicle cameras for monitoring off-road terrain. An example vehicle includes cameras to capture images of terrain, a display, and a controller. The controller is to stitch the images together into an overhead image of the terrain, create an interface that overlays a vehicle outline onto the overhead image, and present the interface via the display. The controller also is to detect, based upon the images, a highest portion of the terrain beneath the vehicle and animate the highest portion of the terrain within the interface.

### TECHNICAL FIELD

The present disclosure generally relates to vehicles cameras and, more specifically, to vehicle cameras for monitoring off-road terrain.

### BACKGROUND

Typically, land vehicles (e.g., cars, trucks, buses, motorcycles, etc.) are capable of traveling on a paved or gravel surface. Some land vehicles are off-road vehicles that also are capable of traveling on unpaved and non-gravel surfaces. For instance, off-road vehicles may include large wheels with large treads, a body that sits high above a ground surface and/or a powertrain that produces increased torque or traction to enable the off-road vehicles to travel along the unpaved and non-gravel surfaces. Oftentimes, off-road vehicles are utilized for sporting, agricultural, or militaristic purposes. For instance, there are many publicly or commercially accessible off-road trails, paths, tracks and/or parks that enable all-terrain vehicle enthusiasts to drive their off-road vehicles on natural or man-made off-road terrain.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for off-road vehicle cameras for terrain monitoring. An example disclosed vehicle includes cameras to capture images of terrain, a display, and a controller. The controller is to stitch the images together into an overhead image of the terrain, create an interface that overlays a vehicle outline onto the overhead image, and present the interface via the display. The controller also is to detect, based upon the images, a highest portion of the terrain beneath the vehicle and animate the highest portion of the terrain within the interface.

In some examples, the cameras include upper cameras and lower cameras. In some such examples, the upper cameras include a front camera, a rear camera, and side cameras. In some such examples, the lower cameras include a front camera, a rear camera, side cameras, and a center camera. Some examples further include proximity sensors to further enable the controller in detecting the highest portion of the terrain beneath the vehicle.

In some examples, the controller is configured to identify a lowest portion of the vehicle. Some such examples further include a hitch and a powertrain differential. In such examples, the lowest portion includes at least one of the hitch and the powertrain differential. In some such examples, the controller is configured to include the lowest portion of the vehicle in the vehicle outline of the interface and animate the lowest portion of the vehicle within the interface.

In some examples, the controller is configured to predict whether an elevated portion of the terrain beneath the vehicle is to collide with a low portion of the vehicle. In some such examples, in response to predicting a potential collision between the elevated portion of the terrain and the low portion of the vehicle, the controller is configured to animate the elevated portion of the terrain and the low portion of the vehicle within the interface. In some such examples, in response to predicting a potential collision between the elevated portion of the terrain and the low portion of the vehicle, the controller is configured to emit an alert to avoid the elevated portion of the terrain from interfering with vehicle movement. In some such examples, in response to predicting a potential collision between the elevated portion of the terrain and the low portion of the vehicle, the controller is configured to determine and provide instructions to a driver for avoiding the potential collision. Some examples further include an autonomy unit. In such examples, in response to the controller predicting a potential collision between the elevated portion of the terrain and the low portion of the vehicle, the autonomy unit is configured to perform autonomous motive functions to avoid the potential collision.

In some examples, the display includes at least one of a center console display and a heads-up display.

An example disclosed method includes capturing, via cameras, images of terrain surrounding a vehicle and stitching, via a processor, the images together into an overhead image of the terrain. The example disclosed method also includes creating, via the processor, an interface that overlays a vehicle outline onto the overhead image and presenting the interface via a display. The example disclosed method also includes detecting, based upon the images, a highest portion of the terrain beneath the vehicle and animating the highest portion within the interface.

Some examples further include identifying a lowest portion of the vehicle within the interface.

Some examples further include predicting whether an elevated portion of the terrain beneath the vehicle is to collide with a low portion of the vehicle. Some such examples further include, in response to predicting a potential collision between the elevated portion of the terrain and the low portion of the vehicle, animating the elevated portion of the terrain and the low portion of the vehicle within the interface. Some such examples further include, in response to predicting a potential collision between the elevated portion of the terrain and the low portion of the vehicle, determining and providing instructions to a driver for avoiding the potential collision with the elevated portion of the terrain. Some such examples further include, in response to the controller predicting a potential collision between the elevated portion of the terrain and the low portion of the vehicle, performing autonomous motive functions via an autonomy unit to avoid the potential collision with the elevated portion of the terrain.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle in accordance with the teachings herein.

FIG. 2 illustrates a powertrain of the vehicle of FIG. 1.

FIG. 3 depicts the vehicle of FIG. 1 driving over terrain.

FIG. 4 depicts an example interface for the vehicle of FIG. 1.

FIG. 5 depicts another example interface for the vehicle of FIG. 1.

FIG. 6 is a block diagram of electronic components of the vehicle of FIG. 1.

FIG. 7 is a flowchart for monitoring off-road terrain via vehicle cameras in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Typically, land vehicles (e.g., cars, trucks, buses, motorcycles, etc.) are capable of traveling on a paved or gravel surface. Some land vehicles are off-road vehicles that also are capable of traveling on unpaved and non-gravel surfaces. For instance, off-road vehicles may include large wheels with large treads, a body that sits high above a ground surface and/or a powertrain that produces increased torque or traction to enable the off-road vehicles to travel along the unpaved and non-gravel surfaces. Oftentimes, off-road vehicles oftentimes are utilized for sporting, agricultural, or militaristic purposes. For instance, there are many publicly or commercially accessible off-road trails, paths, tracks and/or parks that enable all-terrain vehicle enthusiasts to drive their off-road vehicles on natural or man-made off-road terrain. In some instances, an off-road vehicle may traverse over elevated portions of terrain (e.g., rocks, culverts, etc.) that contacts with an underside of the off-road vehicle. The collision between the elevated terrain and the underside of the off-road vehicle potentially may interfere with subsequent movement of the off-road vehicle. In some instances, a spotter may be used to instruct a driver in maneuvering the off-road vehicle to avoid contact with the elevated terrain.

Example methods and apparatus disclosed herein include creates an interface in which an outline of a vehicle overlies an overhead view of terrain to facilitate identification and avoidance of collisions with elevated terrain beneath the vehicle. Examples disclosed herein include a vehicle (e.g., an off-road vehicle) that monitors terrain (e.g., off-road terrain) beneath and/or around itself to facilitate a vehicle operator in avoiding obstacles within the terrain. The vehicle includes cameras (e.g., front cameras, rear cameras, side cameras, underbody cameras, etc.) to capture images of the terrain surrounding the vehicle. A controller of the vehicle stitch the images together to form a real-time overhead view of the terrain. A display of the vehicle presents an interface that includes an outline of the vehicle superimposed over a portion of the terrain in the overhead view. The display presents the interface to enable the operator to identify a position of an object of the terrain relative to the vehicle. In some examples, the controller animates the interface to identify a highest portion of the terrain underneath the vehicle and/or a lowest portion of the vehicle near the terrain. In some examples, the controller determines whether the highest portion and/or another portion of the terrain is to interfere with movement of the vehicle. Upon identifying that the terrain will interfere with movement of the vehicle, the controller (i) emits an alert to the operator, (ii) animates portion(s) of the interface to indicate predicted contact points between the vehicle and the terrain, (iii) provides instructions to the operator to avoid interference with the terrain, and/or (iv) performs autonomous motive functions of the vehicle to avoid interference with the terrain.

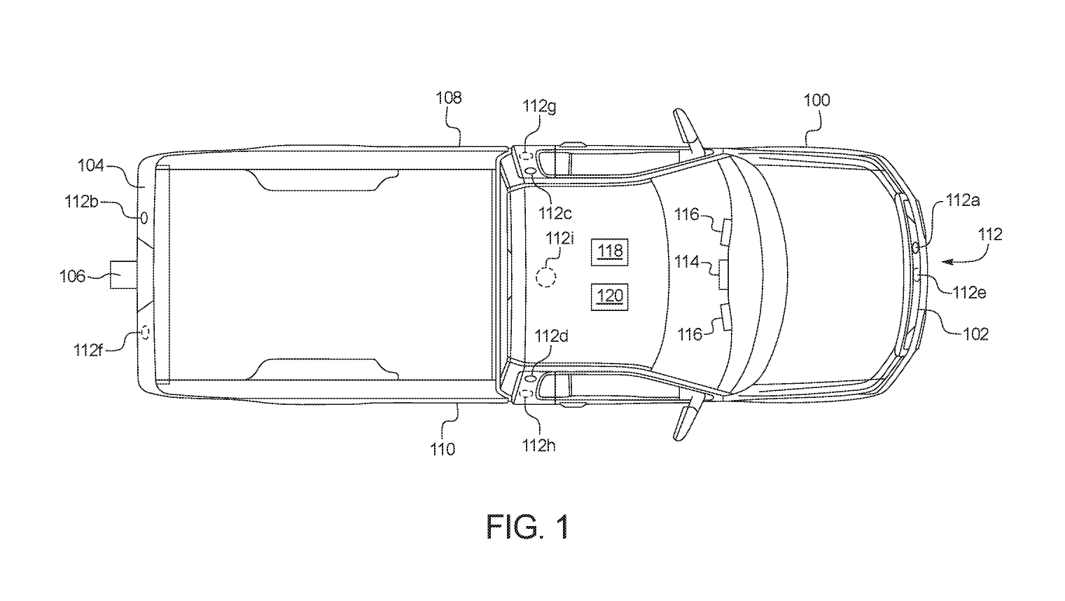

Turning to the figures, FIG. 1 illustrates an example vehicle 100 (e.g., an off-road vehicle) in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input).

In the illustrated example, the vehicle 100 includes a front bumper 102, a rear bumper 104, a hitch 106 (also referred to as a trailer hitch) extending beyond the rear bumper 104, a side frame 108 (also referred to as a first side frame or a driver-side frame), and a side frame 110 (also referred to as a second side frame or a passenger-side frame). Further, the vehicle 100 includes cameras 112 that capture image(s) and/or video of a surrounding area of the vehicle 100.

In the illustrated example, a camera 112a (also referred to as a first camera or an upper front camera) is coupled and/or located adjacent to the front bumper 102 to enable the camera 112a to capture image(s) and/or video of terrain in front of the vehicle 100. A camera 112b (also referred to as a second camera or an upper rear camera) is coupled and/or located adjacent to the rear bumper 104 to enable the camera 112b to capture image(s) and/or video of terrain behind the vehicle 100. A camera 112c (also referred to as a third camera, a first upper side camera, or an upper driver-side camera) is coupled and/or located adjacent to the side frame 108 to enable the camera 112c to capture image(s) and/or video of terrain near the driver-side of the vehicle 100. A camera 112d (also referred to as a fourth camera, a second upper side camera, an upper passenger-side camera) is coupled and/or located adjacent to the side frame 110 to enable the camera 112d to capture image(s) and/or video of terrain near the passenger-side of the vehicle 100. A camera 112e (also referred to as a fifth camera or a lower front camera) is located below the front bumper 102 to enable the camera 112e to capture image(s) and/or video of terrain located near the front bumper 102. A camera 112f (also referred to as a sixth camera or a lower rear camera) is located below the rear bumper 104 to enable the camera 112f to capture image(s) and/or video of terrain located near the rear bumper 104. A camera 112g (also referred to as a seventh camera, a first lower side camera, or a lower driver-side camera) is located below the side frame 108 to enable the camera 112g to capture image(s) and/or video of an terrain located near the side frame 108. A camera 112h (also referred to as an eighth camera, a second lower side camera, or a lower passenger-side camera) is located below the side frame 110 to enable the camera 112h to capture image(s) and/or video of an terrain located near the side frame 110. A camera 112i (also referred to as a ninth camera or a lower center camera) is located below and near a center portion of a floor-pan of vehicle 100 to enable the camera 112i to capture image(s) and/or video of an terrain located below a center portion of the vehicle 100.

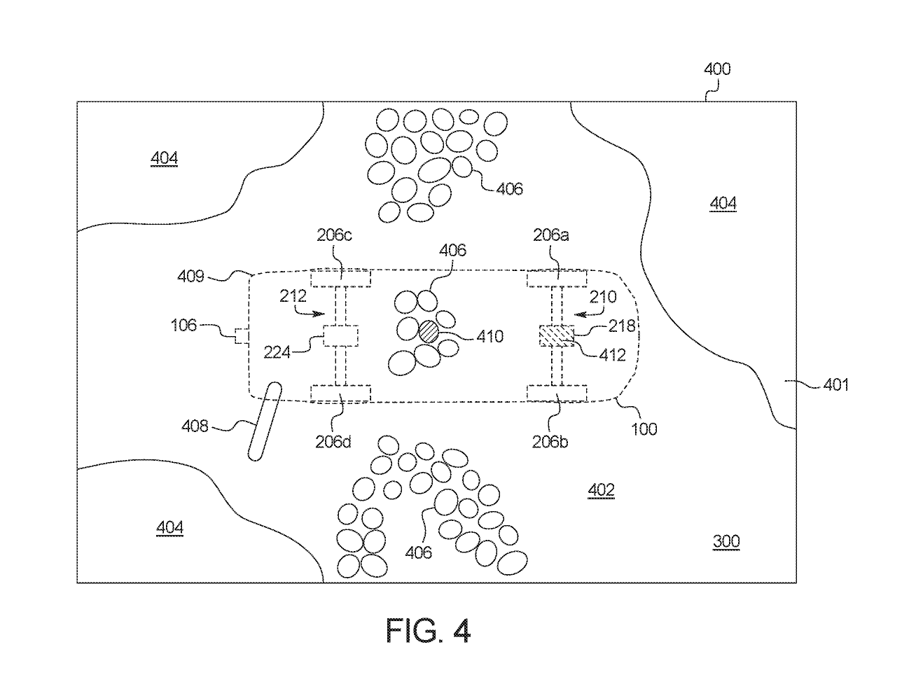

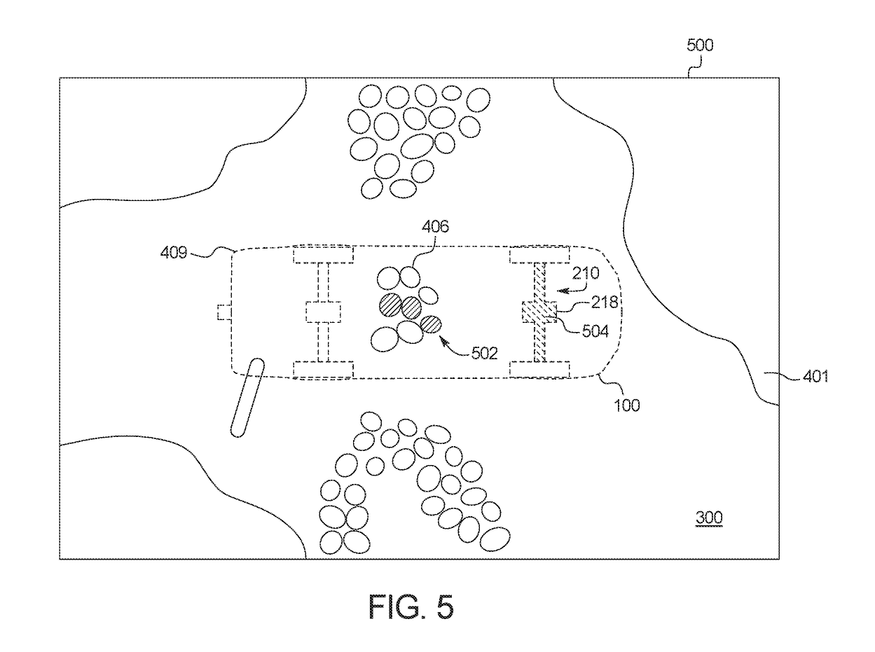

The vehicle 100 of the illustrated example also includes a display 114 and speakers 116. For example, the display 114 presents visual information (e.g., entertainment, instructions, etc.) to occupant(s) of the vehicle 100, and the speakers 116 present audio information (e.g., entertainment, instructions, etc.) to the occupant(s). In the illustrated example, the display 114 includes a heads-up display, a center console display (e.g., a liquid crystal display (LCD), an organic light emitting diode (OLED) display, a flat panel display, a solid state display, etc.), and/or any other display that is configured to present images (e.g., an interface 400 of FIG. 4, an interface 500 of FIG. 5) to the vehicle occupant(s). In some examples, the display 114 is a touchscreen that is configured to receive tactile input from the vehicle occupant(s).

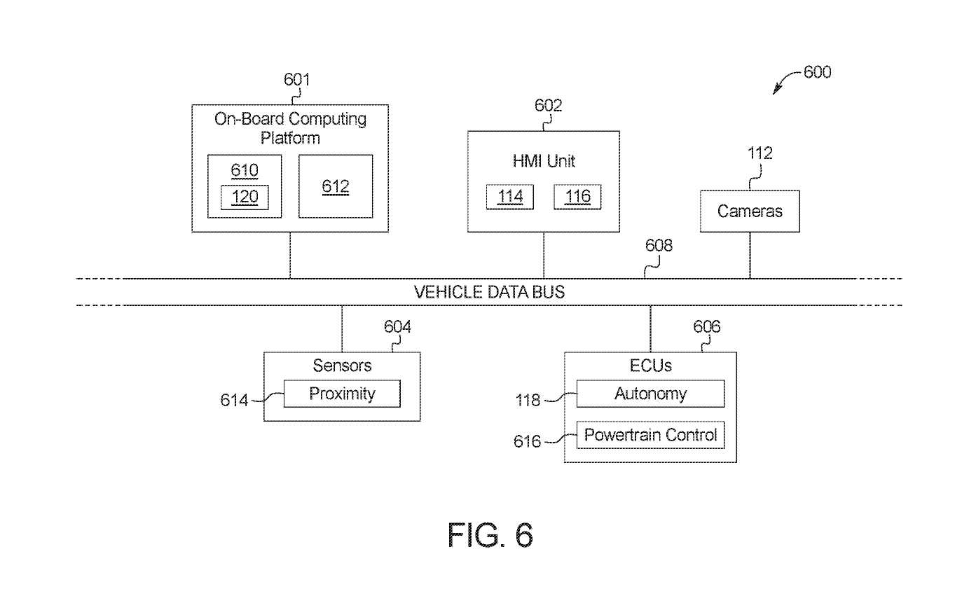

Further, the vehicle 100 of the illustrated example includes an autonomy unit 118. For example, the autonomy unit 118 is configured to control performance of autonomous and/or semi-autonomous driving maneuvers of the vehicle 100 based upon, at least in part, image(s) and/or video captured by one or more of the cameras 112 and/or data collected by one or more proximity sensors (e.g., proximity sensors 614 of FIG. 6) of the vehicle 100.

The vehicle 100 also includes a terrain controller 120 that is configured to (i) identify potential collision(s) between an underside of the vehicle 100 and elevated portions of terrain and (ii) present interface(s) and/or other output signal(s) that facilitate a driver in avoiding the potential collision(s).

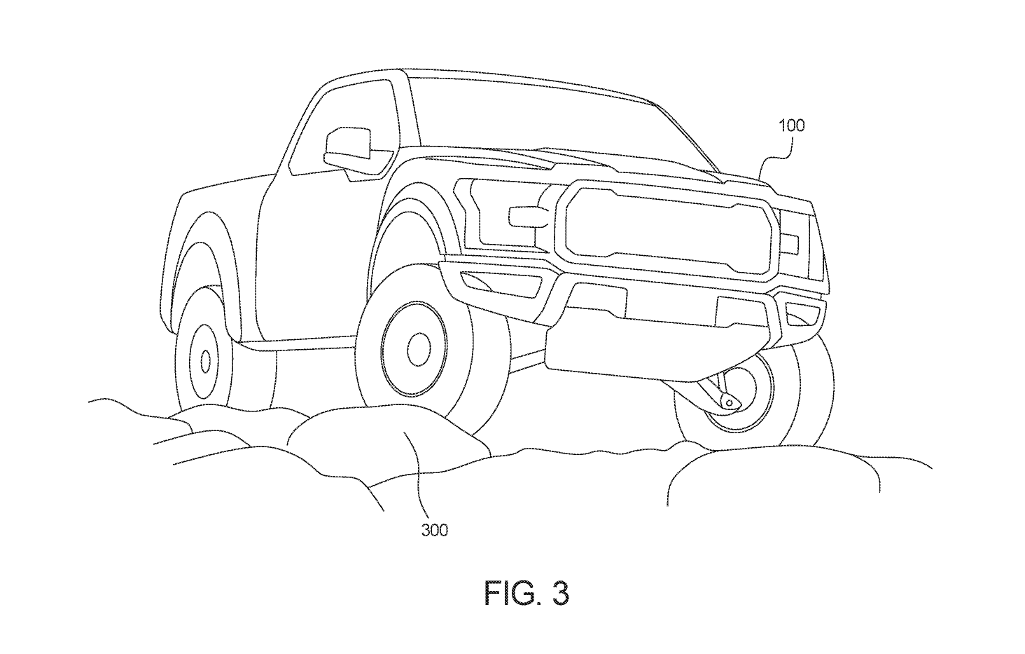

In operation, the terrain controller 120 collects images that are captured by the cameras 112 of the vehicle 100. The terrain controller 120 stitches the images together into an overhead image of terrain (e.g., terrain 300 of FIGS. 3-5) near the vehicle 100. For example, the terrain controller 120 utilizes image stitching software to identify object(s) within each of the collected images, match object(s) that are within a plurality of the collected images, calibrate the collected images with respect to each other, and blend the calibrated images together. The terrain controller 120 also overlays an outline of the vehicle (e.g., an outline 409 of FIGS. 4-5) onto the overhead image of the terrain. Further, the terrain controller 120 creates and presents, via the display 114, an interface (e.g., an interface 400 of FIG. 4, an interface 500 of FIG. 5) in which the outline of the vehicle 100 overlies the overhead image of the terrain.

The terrain controller 120 of the illustrated example also is configured to detect elevated portion(s) of the terrain and/or other object(s) beneath and adjacent to the vehicle 100. For example, the terrain controller 120 detects a highest portion and/or other elevated portion(s) of the terrain beneath the vehicle 100 based upon the images captured by the cameras 112 and/or the overhead image formed from the captured images. In some examples, the vehicle 100 includes one or more proximity sensors (e.g., proximity sensors 614 of FIG. 6) that are utilized to further enable the terrain controller 120 in detecting the highest portion and/or other elevated portion(s) of the terrain beneath the vehicle 100. The terrain controller 120 also is configured to animate the highest portion and/or other elevated portion(s) of the terrain within the interface presented via the display 114 to facilitate a driver in avoiding contact between an underside of the vehicle and those elevated portion(s) of terrain.

Additionally or alternatively, the terrain controller 120 is configured to identify low portions of the terrain beneath and adjacent to the vehicle 100. For example, the terrain controller 120 is configured to identify portions of the vehicle 100 that protrude downward from a floor-pan of the vehicle 100. For example, the terrain controller 120 detects a lowest portion and/or other low portion(s) of the vehicle 100 based upon the images captured by the cameras 112, the overhead image formed from the captured images, and/or data collected from the proximity sensors. Additionally or alternatively, identification of the lowest portion and/or other low portion(s) of the vehicle 100 may be stored in memory (e.g., memory 612 of FIG. 6) of the vehicle 100. In some such examples, the terrain controller 120 is configured to retrieve identification of the lowest portion and/or other low portion(s) of the vehicle 100 from the vehicle memory. Further, the terrain controller 120 is configured to animate the lowest portion and/or other low portion(s) of the vehicle 100 via the display 114 to facilitate a driver in avoiding contact between an underside of the vehicle and those elevated portion(s) of terrain.

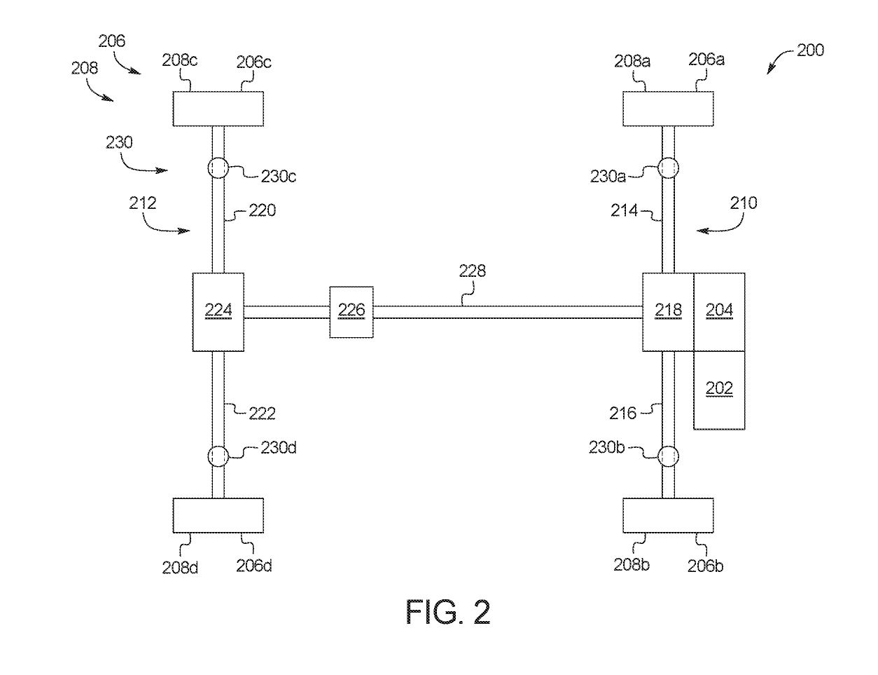

FIG. 2 illustrates a powertrain 200 of the vehicle 100. The powertrain 200 include components of the vehicle 100 that generate power and transfer that power onto a surface (e.g., off-road terrain) along which the vehicle 100 travels to propel the vehicle 100 along that surface. As illustrated in FIG. 2, the powertrain 200 includes an engine 202, a transmission 204, and wheels 206. The engine 202 converts stored energy (e.g., fuel, electrical energy) into mechanical energy to propel the vehicle 100. For example, the engine 202 includes an internal combustion engine, an electric motor, and/or a combination thereof. The transmission 204 controls an amount of power generated by the engine 202 that is transferred to other components of the powertrain 200 (e.g., the wheels 206). For example, the transmission 204 includes a gearbox that controls the amount of power transferred to the wheels 206 of the vehicle 100.

The wheels 206 of the vehicle 100 engage the surface along which the vehicle 100 travels to propel the vehicle 100 along the surface. In the illustrated example, the wheels 206 include a wheel 206a (e.g., a first wheel, a front driver-side wheel), a wheel 206b (e.g., a second wheel, a front passenger-side wheel), a wheel 206c (e.g., a third wheel, a rear driver-side wheel), and a wheel 206d (e.g., a fourth wheel, a rear passenger-side wheel). Further, the wheels 206 have respective tires 208 that engage the surface along which the vehicle 100 travels. In the illustrated example, the tires 208 include a tire 208a (e.g., a first tire, a front driver-side tire), a tire 208b (e.g., a second tire, a front passenger-side tire), a tire 208c (e.g., a third tire, a rear driver-side tire), and a tire 208d (e.g., a fourth tire, a rear passenger-side tire).

Additionally, the powertrain 200 of the illustrated example includes an axle 210 (e.g., a first axle, a front axle) and an axle 212 (e.g., a second axle, a rear axle). The axle 210 includes a shaft 214 (e.g., a first shaft, a front driver-side shaft) and a shaft 216 (e.g., a second shaft, a front passenger-side shaft) that are coupled together via a differential 218 (e.g., a first differential, a front differential). As illustrated in FIG. 2, the wheel 206a is coupled to the shaft 214 of the axle 210, and the wheel 206b is coupled to the shaft 216 of the axle 210. The differential 218 (e.g., a mechanical differential, an electronic differential, a non-locking differential, a locking differential) controls the shaft 214 and the shaft 216 of the axle 210. In some examples, the differential 218 is a locking differential that enables the wheel 206a and the wheel 206b to rotate at different rotational speeds. For example, when a locking differential is in an off-setting, the locking differential enables the shaft 214 and the shaft 216 and, thus, the wheel 206a and the wheel 206b to rotate at different rotational speeds relative to each other. When the locking differential is in an on-setting, the locking differential causes the shaft 214 and the shaft 216 and, thus, the wheel 206a and the wheel 206b to rotate together at same rotational speed relative to each other.

Similarly, the axle 212 includes a shaft 220 (e.g., a third shaft, a rear driver-side shaft) and a shaft 222 (e.g., a fourth shaft, a rear passenger-side shaft) that are coupled together via a differential 224 (e.g., a second differential, a rear differential). As illustrated in FIG. 2, the wheel 206c is coupled to the shaft 220 of the axle 212, and the wheel 206d is coupled to the shaft 222 of the axle 212. The differential 224 (e.g., a mechanical differential, an electronic differential, a non-locking differential, a locking differential) controls the shaft 220 and the shaft 222 of the axle 212. In some examples, the differential 218 is a locking differential that enables the wheel 206c and the wheel 206d to rotate at different rotational speeds. For example, when a locking differential is in an off-setting the locking differential enables the shaft 220 and the shaft 222 and, thus, the wheel 206c and the wheel 206d to rotate at different rotational speeds relative to each other. When the locking differential is in an on-setting, the locking differential causes the shaft 220 and the shaft 222 and, thus, the wheel 206c and the wheel 206d to rotate together at same rotational speed relative to each other.

The powertrain 200 of the illustrated example also includes a transfer case 226 that transmits power from the transmission 204 to the axle 210 and the axle 212 via a driveshaft 228. For example, the transfer case 226 is configured to rotatably couple the axle 210 and the axle 212 together such that the axle 210 and the axle 212 rotate synchronously. Further, the powertrain 200 of the illustrated example includes a suspension 230. For example, the suspension 230 (e.g., air suspension, electromagnetic suspension, etc.) maintains contact between the wheels 206 and the surface along which the vehicle 100 travels to enable the vehicle 100 to propel along the surface. In the illustrated example, the suspension 230 includes a suspension 230a (e.g., a first suspension, a front driver-side suspension), a suspension 230b (e.g., a second suspension, a front passenger-side suspension), a suspension 230c (e.g., a third suspension, a rear driver-side suspension), and a suspension 230d (e.g., a fourth suspension, a rear passenger-side suspension).

FIG. 3 depicts the vehicle 100 driving over terrain 300 that potentially may collide with one or more components of the powertrain 200 and/or the hitch 106 and, in turn, interfere with the vehicle 100 traversing the terrain 300. For example, one or more components of the powertrain 200 (e.g., the axle 210, the axle 212, the shaft 214, the shaft 216, the differential 218, the shaft 220, the shaft 222, the differential 224, the transfer case 226, the driveshaft 228, the suspension 230) are located and/or extend below a floor-pan of the vehicle 100 such that those components potentially are exposed to collisions with the terrain 300.

FIG. 4 depicts an example interface 400 that is presented by the terrain controller 120 via the display 114 of the vehicle 100. As illustrated in FIG. 4, the interface 400 includes an overhead image 401 of the terrain 300. In the illustrated example, the overhead image 401 of the terrain 300 includes a terrain type 402 (e.g., dirt), a terrain type 404 (e.g., grass), a terrain type 406 (e.g., rocks), and a terrain type 408 (e.g., a culvert).

Further, the interface 400 includes an outline 409 of the vehicle 100 that overlies a portion of the overhead image 401 of the terrain 300. In the illustrated example, the outline 409 of the vehicle 100 overlies a portion of the terrain type 402, a portion of the terrain type 406 (e.g., rocks), and a portion of the terrain type 408. In the illustrated example, the outline 409 includes the wheels 206 (i.e., the wheel 206a, the wheel 206b, the wheel 206c, and the wheel 206d) of the vehicle 100. Additionally, the outline 409 includes other components of the vehicle 100 that protrude from an underside of the vehicle 100. In the illustrated example, the outline 409 includes the hitch 106, the axle 210, the axle 212, the differential 218, and the differential 224.

The interface 400 of the illustrated example identifies a highest portion of the terrain 300 beneath the vehicle 100 and/or a lowest portion of the vehicle 100 to facilitate a vehicle driver in preventing the terrain 300 from interfering with movement of the vehicle 100. For example, the highest portion of the terrain 300 beneath the vehicle 100 is a portion of the terrain type 406, and the lowest portion of the vehicle 100 is the differential 218. In other examples, the lowest portion of the vehicle 100 is the differential 224, the hitch 106, the axle 210, the axle 212, and/or any other component of the vehicle 100.

As illustrated in FIG. 4, the interface 400 includes an animation 410, a highlight and/or other indicator to inform the driver of a location of the highest portion of the terrain 300 beneath the vehicle 100 relative to the vehicle 100. Further, the interface 400 includes an animation 412, a highlight and/or other indicator to inform the driver of a location of the lowest portion of the vehicle 100 relative to the terrain 300. In some examples, the interface 400 includes a relative elevation of the highest portion of the terrain 300 and/or a relative elevation of the lowest portion of the vehicle 100 to further facilitate the vehicle driver in avoiding interference between the vehicle 100 and the terrain 300.

FIG. 5 depicts another example interface 500 that is presented by the terrain controller 120 via the display 114 of the vehicle 100. As illustrated in FIG. 5, the interface 500 includes the overhead image 401 of the terrain 300 and the outline 409 of the vehicle 100.

The interface 500 of the illustrated example identifies elevated portion(s) of the terrain 300 beneath the vehicle 100 and/or low portion(s) of the vehicle 100 to facilitate a vehicle driver in preventing the terrain 300 from interfering with movement of the vehicle 100. For example, the elevated portions of the terrain 300 beneath the vehicle 100 include portions of the terrain type 406, and the low portions of the vehicle 100 include the axle 210 and the differential 218. In other examples, the low portion(s) of the vehicle 100 is the differential 224, the hitch 106, the axle 212, and/or any other component of the vehicle 100.

In the illustrated example, the elevated portion(s) and the low portion(s) that are identified within the interface 500 include portions of the terrain 300 and the vehicle 100, respectively, that the terrain controller 120 predicts are to collide with each other. That is, the terrain controller 120 is configured to predict whether the elevated portion(s) of the terrain 300 beneath the vehicle 100 are to collide with the low portion(s) of the vehicle 100. Further, the terrain controller 120 is configured to predict which portion(s) of the terrain 300 beneath the vehicle 100 (e.g., portions of the terrain type 406) are to collide with which portion(s) of the vehicle 100 (e.g., the axle 210 and the differential 218). In some examples, the terrain controller 120 identifies potential collisions between the elevated portion(s) of the terrain 300 and the low portion(s) of the vehicle 100 based upon a current trajectory of the vehicle 100. Additionally or alternatively, the terrain controller 120 identifies potential collisions between the elevated portion(s) of the terrain 300 and the low portion(s) of the vehicle 100 based upon potential trajectories of the vehicle 100.

In the illustrated example, the terrain controller 120 animates the elevated portion(s) of the terrain 300 and the low portion(s) of the vehicle 100 within the interface 500 in response to predicting a potential collision between the elevated portion(s) of the terrain 300 and the low portion(s) of the vehicle 100. For example, the interface 500 includes an animation 502, a highlight and/or other indicator to inform the driver of a location of the elevated portion(s) of the terrain 300 beneath the vehicle 100 that are predicted to potentially interfere with movement of the vehicle 100. Further, the interface 500 includes an animation 504, a highlight and/or other indicator to inform the driver of a location of the low portion(s) of the vehicle 100 that are predicted to potentially collide with the elevated portion(s) of the terrain 300. In some examples, the interface 500 includes relative elevation(s) of the elevated portion(s) of the terrain 300 and/or relative elevation(s) of the low portion(s) of the vehicle 100 to further facilitate the vehicle driver in avoiding interference between the vehicle 100 and the terrain 300.

Additionally or alternatively, the terrain controller 120 is configured to emit an alert and/or provide instructions for a driver in response to predicting a potential collision between the elevated portion(s) of the terrain 300 and the low portion(s) of the vehicle 100. For example, the terrain controller 120 emits an alert (e.g., a visual alert via the display 114, an audio alert via the speakers 116) to inform the driver of the potential collision with the terrain 300. The terrain controller 120 determines and provides the instructions (e.g., slowly turn 45 degrees in a rightward direction) to guide the driver in avoiding the potential collision with the terrain. In some examples, the instructions include visual instructions provided via the display 114 and/or audio instructions provided via the speakers 116. Further, the autonomy unit 118 is configured to perform autonomous motive functions of the vehicle 100 to avoid the elevated portion(s) of the terrain 300 in response to the terrain controller 120 predicting a potential collision between the elevated portion(s) of the terrain 300 and the low portion(s) of the vehicle 100. For example, upon detecting the potential collision, the terrain controller 120 sends signal(s) to activate the autonomous control of the autonomy unit 118.

FIG. 6 is a block diagram of electronic components 600 of the vehicle 100. As illustrated in FIG. 6, the electronic components 600 include an on-board computing platform 601, an human-machine interface (HMI) unit 602, sensors 604, electronic control units (ECUs) 606, and a vehicle data bus 608.

The on-board computing platform 601 includes a microcontroller unit, controller or processor 610 and memory 612. In some examples, the processor 610 of the on-board computing platform 601 is structured to include the terrain controller 120. Alternatively, in some examples, the terrain controller 120 is incorporated into another electronic control unit (ECU) with its own processor and memory. The processor 610 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 612 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 612 includes multiple kinds of memory, particularly volatile memory and non-volatile memory.

The memory 612 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 612, the computer readable medium, and/or within the processor 610 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The HMI unit 602 provides an interface between the vehicle 100 and a user. The HMI unit 602 includes digital and/or analog interfaces (e.g., input devices and output devices) to receive input from and display information for the user(s). The input devices include, for example, a control knob, an instrument panel, a digital camera for image capture and/or visual command recognition, a touchscreen, an audio input device (e.g., cabin microphone), buttons, or a touchpad. The output devices may include instrument cluster outputs (e.g., dials, lighting devices), actuators, the display 114, and/or the speakers 116. In some examples, the HMI unit 602 includes hardware (e.g., a processor or controller, memory, storage, etc.) and software (e.g., an operating system, etc.) for an infotainment system (such as SYNC® and MyFord Touch® by Ford®). In such examples, the HMI unit 602 displays the infotainment system via the display 114.

The sensors 604 are arranged in and around the vehicle 100 to monitor properties of the vehicle 100 and/or an environment in which the vehicle 100 is located. One or more of the sensors 604 may be mounted to measure properties around an exterior of the vehicle 100. Additionally or alternatively, one or more of the sensors 604 may be mounted inside a cabin of the vehicle 100 or in a body of the vehicle 100 (e.g., an engine compartment, wheel wells, etc.) to measure properties in an interior of the vehicle 100. For example, the sensors 604 include accelerometers, odometers, tachometers, pitch and yaw sensors, wheel speed sensors, microphones, tire pressure sensors, biometric sensors and/or sensors of any other suitable type.

In the illustrated example, the sensors 604 include one or more proximity sensors 614. For example, the proximity sensors 614 collect data to detect a presence and/or location of a nearby object (e.g., the terrain 300). In some examples, the proximity sensors 614 include radar sensor(s) that detect and locate an object via radio waves, lidar sensor(s) that detect and locate an object via lasers, and/or ultrasonic sensor(s) that detect and locate an object via ultrasound waves.

The ECUs 606 monitor and control the subsystems of the vehicle 100. For example, the ECUs 606 are discrete sets of electronics that include their own circuit(s) (e.g., integrated circuits, microprocessors, memory, storage, etc.) and firmware, sensors, actuators, and/or mounting hardware. The ECUs 606 communicate and exchange information via a vehicle data bus (e.g., the vehicle data bus 608). Additionally, the ECUs 606 may communicate properties (e.g., status of the ECUs 606, sensor readings, control state, error and diagnostic codes, etc.) to and/or receive requests from each other. For example, the vehicle 100 may have dozens of the ECUs 606 that are positioned in various locations around the vehicle 100 and are communicatively coupled by the vehicle data bus 608.

In the illustrated example, the ECUs 606 include the autonomy unit 118 and a powertrain control module 616. For example, the powertrain control module 616 is configured to operate the differential 218, the differential 224, and/or the transfer case 226 to control an amount of power generated for propelling the vehicle 100 along the terrain 300. In some examples, the powertrain control module 616 controls the differential 218 and/or the differential 224 via one or more corresponding differential controllers and controls the transfer case 226 via a corresponding transfer case controller.

The vehicle data bus 608 communicatively couples the cameras 112, the on-board computing platform 601, the HMI unit 602, the sensors 604, and the ECUs 606. In some examples, the vehicle data bus 608 includes one or more data buses. The vehicle data bus 608 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

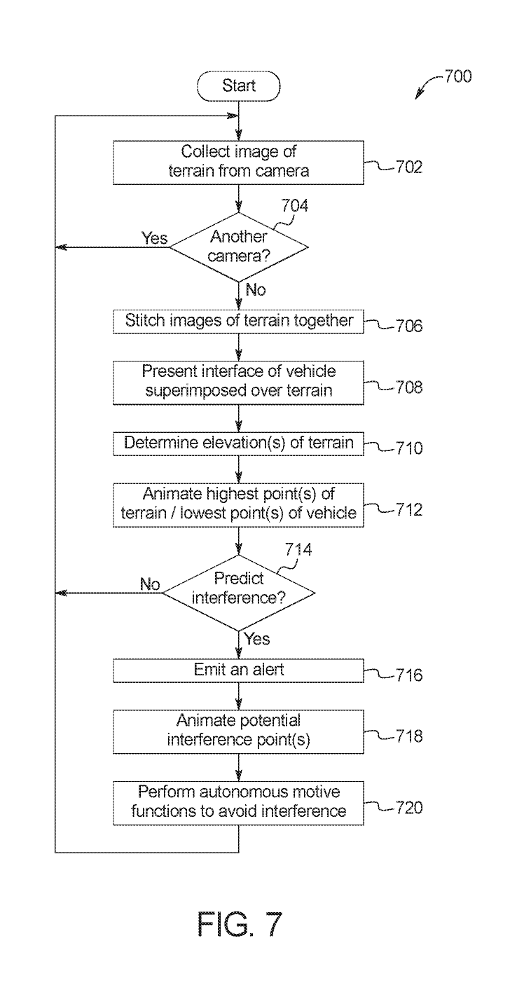

FIG. 7 is a flowchart of an example method 700 to monitoring off-road and/or other terrain via vehicle cameras. The flowchart of FIG. 7 is representative of machine readable instructions that are stored in memory (such as the memory 612 of FIG. 6) and include one or more programs which, when executed by a processor (such as the processor 610 of FIG. 6), cause the vehicle 100 to implement the example terrain controller 120 of FIGS. 1 and 6. While the example program is described with reference to the flowchart illustrated in FIG. 7, many other methods of implementing the example terrain controller 120 may alternatively be used. For example, the order of execution of the blocks may be rearranged, changed, eliminated, and/or combined to perform the method 700. Further, because the method 700 is disclosed in connection with the components of FIGS. 1-6, some functions of those components will not be described in detail below.

Initially, at block 702, the terrain controller 120 collects an image of the terrain 300 from one of the cameras 112 of the vehicle 100. That is, the terrain controller 120 collects an image of the terrain 300 that is captured by one of the cameras 112. At block 704, the terrain controller 120 determines whether there is another one of the cameras 112 from which to collect an image of the terrain 300. In response to the terrain controller 120 determining that there is another one of the cameras 112, the method 700 returns to block 702. Otherwise, in response to the terrain controller 120 determining that there is not another one of the cameras 112, the method 700 proceeds to block 706.

At block 706, the terrain controller 120 stitches the images captured by the cameras 112 together to form an overhead view of the terrain 300. Further, the terrain controller 120 superimposes an outline of the vehicle 100 over the terrain 300 in the overhead view At block 708, the terrain controller 120 presents, via the display 114, the interface 400 that shows the outline of the vehicle 100 superimposed over the terrain 300 in the overhead view. At block 710, the terrain controller 120 determines elevation level(s) of the terrain 300 relative to the vehicle 100 to identify the highest and/or other elevated portion(s) of the terrain 300 near the vehicle 100. Further, the terrain controller 120 identifies the lowest and/or other low portion(s) of the vehicle 100. At block 712, the terrain controller 120 presents, via the display 114, the interface 400 that includes animation(s) of the highest portion(s) of the terrain 300 and/or the lowest portion(s) of the vehicle 100.

At block 714, the terrain controller 120 determines whether the terrain 300 under the vehicle 100 is to interfere with movement of the vehicle 100. For example, the terrain controller 120 predicts whether the elevated portion(s) of the terrain 300 underneath the vehicle 100 is to collide with the low portion(s) of the vehicle 100. In response to the terrain controller 120 determining that the terrain 300 will not interfere with movement of the vehicle 100, the method 700 returns to block 702. Otherwise, in response to the terrain controller 120 determining that the terrain 300 will interfere with movement of the vehicle 100, the method 700 returns to block 716.

At block 716, the terrain controller 120 emits an alert, for example, via the display 114 and/or the speakers 116. The alert is emitted to inform an occupant of the vehicle 100 that the terrain beneath the vehicle 100 is predicted to interfere with movement of the vehicle 100. At block 718, the terrain controller 120 animates potential interference point(s) on the interface 500 presented via the display 114. For example, the terrain controller 120 animates portion(s) of the vehicle 100 and the terrain 300 that are predicted to collide. At block 720, the autonomy unit 118 performs autonomous motive functions for the vehicle 100 to enable the vehicle 100 to avoid colliding with the highest portion(s) of the terrain 300. Alternatively, the terrain controller 120 presents instructions (e.g., via the display 114 and/or the speakers 116) for operating the vehicle to facilitate a driver in avoiding the highest portion(s) of the terrain 300 beneath the vehicle 100.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively. Additionally, as used herein, the terms “module” and “unit” refer to hardware with circuitry to provide communication, control and/or monitoring capabilities, often in conjunction with sensors. A “module” and a “unit” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
cameras to capture images of terrain;
a display; and
a controller to:
stitch the images together into an overhead image of the terrain;
create an interface that overlays a vehicle outline onto the overhead image;
present the interface via the display;
detect, based upon the images, a highest portion of the terrain beneath the vehicle; and
animate the highest portion of the terrain within the interface.

2. The vehicle of claim 1, wherein the cameras include upper cameras and lower cameras.

3. The vehicle of claim 2, wherein the upper cameras include a front camera, a rear camera, and side cameras.

4. The vehicle of claim 2, wherein the lower cameras include a front camera, a rear camera, side cameras, and a center camera.

5. The vehicle of claim 1, further including proximity sensors to further enable the controller in detecting the highest portion of the terrain beneath the vehicle.

6. The vehicle of claim 1, wherein the controller is configured to identify a lowest portion of the vehicle.

7. The vehicle of claim 6, further including a hitch and a powertrain differential, wherein the lowest portion includes at least one of the hitch and the powertrain differential.

8. The vehicle of claim 6, wherein the controller is configured to:
include the lowest portion of the vehicle in the vehicle outline of the interface; and
animate the lowest portion of the vehicle within the interface.

9. The vehicle of claim 1, wherein the controller is configured to predict whether an elevated portion of the terrain beneath the vehicle is to collide with a low portion of the vehicle.

10. The vehicle of claim 9, wherein, in response to predicting a potential collision between the elevated portion of the terrain and the low portion of the vehicle, the controller is configured to animate the elevated portion of the terrain and the low portion of the vehicle within the interface.

11. The vehicle of claim 9, wherein, in response to predicting a potential collision between the elevated portion of the terrain and the low portion of the vehicle, the controller is configured to emit an alert to avoid the elevated portion of the terrain from interfering with vehicle movement.

12. The vehicle of claim 9, wherein, in response to predicting a potential collision between the elevated portion of the terrain and the low portion of the vehicle, the controller is configured to determine and provide instructions to a driver for avoiding the potential collision.

13. The vehicle of claim 9, further including an autonomy unit, wherein, in response to the controller predicting a potential collision between the elevated portion of the terrain and the low portion of the vehicle, the autonomy unit is configured to perform autonomous motive functions to avoid the potential collision.

14. The vehicle of claim 1, wherein the display includes at least one of a center console display and a heads-up display.

15. A method comprising:
capturing, via cameras, images of terrain surrounding a vehicle;
stitching, via a processor, the images together into an overhead image of the terrain;
creating, via the processor, an interface that overlays a vehicle outline onto the overhead image;
presenting the interface via a display;
detecting, based upon the images, a highest portion of the terrain beneath the vehicle; and
animating the highest portion within the interface.

16. The method of claim 15, further including identifying a lowest portion of the vehicle within the interface.

17. The method of claim 15, further including predicting whether an elevated portion of the terrain beneath the vehicle is to collide with a low portion of the vehicle.

18. The method of claim 17, further including, in response to predicting a potential collision between the elevated portion of the terrain and the low portion of the vehicle, animating the elevated portion of the terrain and the low portion of the vehicle within the interface.

19. The method of claim 17, further including, in response to predicting a potential collision between the elevated portion of the terrain and the low portion of the vehicle, determining and providing instructions to a driver for avoiding the potential collision with the elevated portion of the terrain.

20. The method of claim 17, further including, in response to predicting a potential collision between the elevated portion of the terrain and the low portion of the vehicle, performing autonomous motive functions via an autonomy unit to avoid the potential collision with the elevated portion of the terrain.
